(19) United States
(12) Patent Application Publication
(10) Pub. No.: US 2009/0149202 A1
(43) Pub. Date: Jun. 11, 2009

(54) SYSTEM AND METHOD FOR DETERMINATION OF POSITION

(75) Inventors: Lawrence W. Hill, Eastham, MA (US); Christian Steele, Tahoe City, CA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Christian Steele, Tahoe City, CA (US)

(21) Appl. No.: 12/328,343

(22) Filed: Dec. 4, 2008

Related U.S. Application Data
(60) Provisional application No. 61/005,771, filed on Dec. 7, 2007.

(51) Int. Cl. H04W 4/02; G01P 15/00; G01S 1/00

(52) U.S. Cl. 455/456.6; 702/141; 342/357.09

(57) ABSTRACT

A system and method of determining and reporting on the position of a wireless device relative to a group of other wireless devices dispersed within a specified geographic area. The system includes at least one Query Unit, three or more Responding Units disposed at determinable locations within the specified geographic area, and one or more Mobile Units, which may correspond to additional Responding Units or units that function only as receivers. The Query Unit sequentially queries the Responding Units, and, responsive to the respective query messages, the Responding Units transmit corresponding response messages. One or more of the Mobile Units receive the query and response messages, and generate, for each query-response message pair, a set of time-difference-of-arrival (TDOA) measurements, which are used by the Mobile Units to determine their positions relative to the Responding Units. The Mobile Units record the times-of-arrival (TOAs) of the query message and the response messages at their respective receivers, and calculate the TDOAs based on the recorded TOAs. The TDOAs are then analyzed to determine the time differences due to the differences in lengths of the respective message propagation paths. The position of each Mobile Unit can then be computed using computation techniques typically employed in Long Range Navigation (LORAN) receivers, or any other suitable computation technique.

### CROSS REFERENCE TO RELATED APPLICATIONS

This application claims benefit of U.S. Provisional Patent Application No. 61/005,771 filed Dec. 7, 2007 entitled SYSTEM AND METHOD FOR DETERMINATION OF POSITION.

### STATEMENT REGARDING FEDERALLY SPONSORED RESEARCH OR DEVELOPMENT

Not applicable

### FIELD OF THE INVENTION

The present invention relates generally to systems and methods of determining the position of a device, and more specifically to a system and method of determining the position of a device that includes exchanging query and response messages between one or more cooperating devices using electromagnetic or acoustic signal transmissions.

### BACKGROUND OF THE INVENTION

In recent years, there has been an increasing need for low cost, high accuracy systems that can support the autonomous navigation of vehicles such as automated guided vehicles used in material handling systems, and mobile devices such as mobile home appliances (e.g., floor cleaning robots) and automated surveillance and security robots. In addition, there has been an increasing need for low cost, high accuracy systems that can be used for locating and tracking valuable assets, locating and tracking pets and children, military and sports training, gaming and virtual reality applications that track body motion, cellular telephone location for 911, coordination, command, and control of individuals conducting search and rescue and disaster recovery operations, etc.

A conventional system that may be employed in applications such as those listed above can include a mobile device and one or more beacons disposed at predetermined locations. The beacons transmit radio frequency (RF) signals to query the mobile device, and, responsive to the query signals, the mobile device transmits response signals. The propagation delay times of the query and response signals are then measured and used in a triangulation technique to determine the position of the mobile device. Increased accuracy is achieved within this system by maintaining phase-coherence between the query and response signals. Such a conventional system has drawbacks, however, in that it can be difficult to manufacture at low cost, due at least in part to the overall complexity of the system and the high analog filter performance necessary to obtain stable, full duplex operation of the RF circuitry.

### BRIEF SUMMARY OF THE INVENTION

In accordance with the present invention, a system and method is disclosed that can be used to determine and report on the position of a wireless device of a user relative to a group of other remote wireless devices dispersed within a geographic area. For example, the geographic area may correspond to a residential property, a commercial building, a campus, or an urban neighborhood. To increase the range of the presently disclosed system, some of the devices may be located on cellular telephone towers or other points of high visibility, while other devices may be stationary or mobile and situated within the range of the towers. The presently disclosed system and method provides device position information with increased accuracy and reduced cost. In addition, the device whose position is to be determined may be configured to have a reduced size and reduced power requirements, thereby making the device suitable for use within small autonomous vehicles or robots, suitable for being worn by young children, or suitable for being attached to pets.

The presently disclosed system may include at least one mobile or stationary Query Unit, three or more mobile or stationary Responding Units disposed within a geographic area of interest, and one or more passive (i.e., receive-only) Mobile Units. For example, the Query and Responding Units may be stationary devices disposed at predetermined locations within the geographic area of interest, or mobile devices whose locations within the geographic area may be determined using a satellite navigation system such as the U.S. Global Positioning System (GPS), the European Galileo Positioning System, or any other suitable technique. To obtain an accurate determination of device position in 3-dimensional space, a minimum of four transmitting units (e.g., one Query Unit and three Responding Units) are typically employed. However, more than four transmitting units may alternatively be used to obtain redundant measurements that can be employed in combination to achieve increased coverage and accuracy. It is noted that the terms “Query” and “Response” are employed herein to refer to the roles of the respective units in performing a two-way radio propagation delay time measurement. In one embodiment, the Query and Responding Units include identically or substantially the same hardware and software, and the roles of the respective units are determined by selecting an operating mode.

In one mode of operation, a Query Unit broadcasts a sequence of space-time-compressed (STC) digital codes. Barker codes may be employed because of their known autocorrelation properties. In one embodiment, each of the STC codes may be an 11 or 13 bit Barker code or its inversion. The sense (bit-complemented or not bit-complemented) of each Barker code defines a “1” or “0” information bit. The sequence of STC codes includes a query message (also referred to herein as a “polling request”) directed to a specified Responding Unit, which receives and decodes the message, and, after a predetermined delay time, broadcasts a code sequence (i.e., a response message) in response. The code sequences corresponding to the query and response messages are passed through correlators within the Query and Responding Units to determine the times of peak correlation for the respective codes relative to the units' internal clocks. The peak correlation times are then recorded. It is noted that the peak correlation values may be positive or negative, depending on the sense of the information bit carried by the respective code. The peak correlation times for all of the codes are then passed through recursive filters such as Kalman filters within the Query and Responding Units to obtain an accurate measure of the times-of-arrival (TOAs) of the messages at the respective units. The TOAs of the query messages at the Responding Units are used by those units to determine when to transmit the corresponding response messages. Further, the TOAs of the response messages at the Query Unit are used by that unit to obtain accurate measures of the propagation delay times associated with the respective response messages. The TOAs of both the query and response messages at a passive Mobile Unit can also be used by that unit to obtain accurate measures of the propagation delay times associated with the respective query and response messages. Although clock jitter and short-term clock drift over the duration of a query-response message sequence may have a limited effect on measurement error, the absolute timing of the units' clocks does not have any effect on the measurement accuracy.

In a first embodiment of the presently disclosed system, the Query Unit is mobile and operative to query sequentially the plurality of Responding Units, thereby generating a set of pseudo-range measurements based on the propagation delay times associated with the response messages transmitted by the Responding Units and received at the Query Unit. Each pseudo-range measurement can effectively be obtained by comparing the time signal generated by the Responding Unit's clock to the time signal generated by the Query Unit's clock to determine the propagation delay time and, based on the propagation delay time, the range. The Query Unit then uses this set of pseudo-range measurements to determine its own position relative to the Responding Units. For example, the Query Unit may employ a triangulation technique like that employed in GPS receivers, or any other suitable position computation technique.

In a second embodiment of the presently disclosed system, the Query Unit is stationary and operative to query sequentially the plurality of Responding Units. A passive Mobile Unit then receives the query and response messages transmitted by the Query and Responding Units, respectively, and, based on the propagation delay times associated with the query and response messages, generates a set of time-difference-of-arrival (TDOA) measurements, which may subsequently be employed by the passive unit to determine its own position relative to the Query and Responding Units. In this second embodiment, the passive Mobile Unit does not transmit any signals, thereby making its presence difficult for others to detect and reducing its battery requirements. Specifically, the passive Mobile Unit records the times-of-arrival (TOAs) of the query and response messages at its receiver, and calculates the differences between the TOAs to obtain a measure of the time-differences-of-arrival (TDOAs) of the respective messages. Next, based on the measured TDOAs, the passive Mobile Unit determines the differences in the lengths of the corresponding RF signal paths, taking into account a predetermined delay time that expires before each Responding Unit transmits its respective response message. The passive Mobile Unit then determines its position based on these differences in RF signal path lengths. For example, the passive Mobile Unit may compute its position using computational techniques typically employed in Long Range Navigation (LORAN) receivers, or any other suitable position computation technique.

Because the accuracy of propagation delay time measurements is subject to multi-path effects, in one embodiment, the presently disclosed system is configured to apply a first Kalman filter to the TOAs of the respective codes contained in a query or response message packet to improve the accuracy of the TDOA measurements associated with each query-response exchange. Next, the system determines the intersection of multiple TDOA hyperbolae to obtain the coordinates of the passive Mobile Unit, and employs a second Kalman filter to determine a trajectory of the unit that is smoothed and acceleration-gated. The system may also employ a phase weighting algorithm, taking into account that the direct RF signal path to the unit will be the shortest path in a group of paths of varying length, and that the phase of an arriving query/response message signal will tend to be correct at the local maxima and minima of the signal amplitude. In addition, inertial guidance inputs, for example, from low cost MEMS-based accelerometers, may be used to mitigate sudden shifts in apparent position and the resulting large accelerations, which can result from a mobile unit entering or leaving an area where a multipath signal is strong.

In a third embodiment of the presently disclosed system, at least some of the Query and Responding Units are equipped with multiple antennas and receivers. In this third embodiment, a unit employs its antennas to receive an RF signal, and obtains different TDOA measurements depending on the direction from which the received RF signal was transmitted. The different TDOA measurements are then employed in a beam-forming calculation, in which the azimuth and/or elevation angle to the signal source is determined and combined with information relating to the RF signal path length to obtain a more accurate determination of device position. For example, this system embodiment may be implemented with four antennas mounted to the corners of a cellular telephone tower, or any other suitable number of antennas in any other suitable configuration.

In each of the illustrative embodiments described above, the presently disclosed system can be implemented as a half-duplex system, thereby allowing the RF sections within the Query and Responding Units to be constructed using low cost commodity components with reduced filter requirements. Further, because a simple form of phase shift keying (PSK) modulation is employed, the need for high amplifier and receiver linearity and high resolution analog-to-digital conversion (ADC) circuitry (which characterizes current WIFI, WIMAX, and cellular telephone signal structures) is avoided. Moreover, digital signal processing (DSP) in the respective units can be implemented using standard DSP methods instantiated in ASIC technology. In addition, clock errors, including those resulting from low cost crystal timing sources, are minimal due to the short time periods during which clock drift might influence the propagation delay time measurements. Further, because the system performs numerous filtered measurements (i.e., one measurement per information bit in the query/response message), the effects of short-term phase noise are reduced. Because numerous ranging measurements are performed during each query-response exchange (e.g., one measurement per information bit), improved accuracy can also be achieved by averaging over many readings whose error sources are substantially statistically independent of one another.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a diagram illustrating a system for determination of position, according to the present invention;

FIG. 2 is an illustration of the signaling structure employed in the system of FIG. 1;

FIG. 3 is a block diagram of a Query or Responding Unit included in the system of FIG. 1;

FIG. 4 is a diagram illustrating the signaling structure of FIG. 2 at various points in the receive chain of the Query or Responding Unit of FIG. 3;

FIG. 5 is a flow diagram illustrating time-difference-of-arrival (TDOA) and navigation processing performed by the Query or Responding Unit of FIG. 3;

FIG. 6 is a diagram illustrating the system of FIG. 1, including multiple antennas that can be used in a beam-forming process;

FIG. 7 is a flow diagram illustrating the logic for automatic gain control (AGC) optimization based on the variance of measured phase;

FIG. 8 is a first alternative embodiment of the Query or Responding Unit of FIG. 3; and

FIG. 9 is a second alternative embodiment of the Query or Responding Unit of FIG. 3.

### DETAILED DESCRIPTION OF THE INVENTION

The disclosure of U.S. Provisional Patent Application No. 61/005,771 filed Dec. 7, 2007 entitled SYSTEM AND METHOD FOR DETERMINATION OF POSITION is incorporated herein by reference in its entirety.

A system and method is provided that can be used to determine and report on the position of a device relative to a group of other devices dispersed within a specified geographic area.

### System Operation

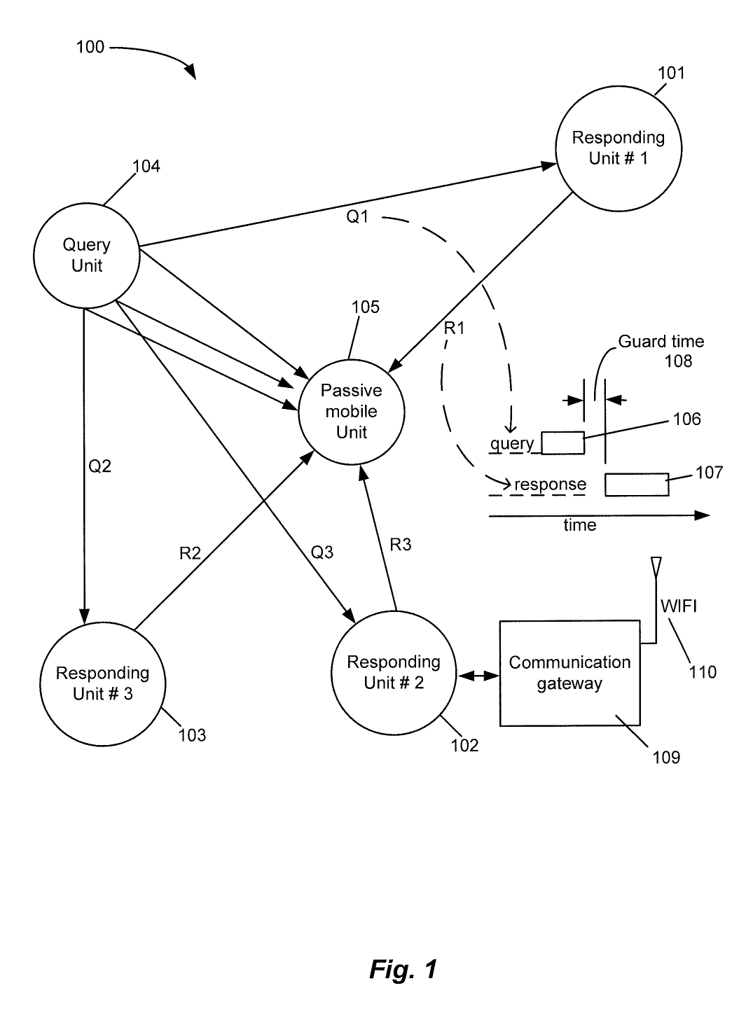

FIG. 1 depicts an illustrative embodiment of a system 100 for determining the position of a device, in accordance with the present invention. As shown in FIG. 1, the system 100 includes a plurality of Responding Units 101, 102, 103, a Query Unit 104, and a passive Mobile Unit 105. For example, the Query and Responding Units 101, 102, 103, 104 may be stationary devices disposed at predetermined locations within the specified geographic area, or mobile devices whose locations within the specified geographic area may be determined using a Global Positioning System (GPS) or any other suitable technique. In the illustrated embodiment, the operation of the system 100 is driven by the Query Unit 104, which transmits a series of query messages Q1, Q2, Q3, each addressed to a different one of the Responding Units 101, 102, 103. After each transmission of a query message Q1, Q2, or Q3 (as illustrated by a block 106), the Responding Unit 101, 102, or 103 whose address matches the address contained in the query message Q1, Q2, or Q3 transmits a response message R1, R2, or R3 (as illustrated by a block 107) after the expiration of a predetermined Guard time 108, which begins at the time of the unit's receipt of the query message. In this way, the system 100 generates a series of query-response message pairs Q1,R1, Q2,R2, and Q3,R3.

When a query-response message pair is generated, each unit other than the one responding (e.g., the passive Mobile Unit 105) detects both the query message and the corresponding response message. The time interval between the detection of the query message and the detection of the response message differs from the predetermined Guard time by an amount representing the range difference between the Query Unit and the Responding Unit relative to the Mobile Unit 105.

It is noted that, responsive to the broadcast of a plurality of radio frequency (RF) signal tones having a specified phase difference, an RF receiver can determine its location based on a measurement of the received phase difference. A single phase difference between two broadcast RF signals can be used to define a hyperbola, three phase differences (resulting from the combination of three pairs of broadcast RF signals) can be used to define a point of intersection of multiple hyperbolae on a plane (or, approximately, on the surface of the earth), and four phase differences (resulting from the combination of four broadcast RF signals) can be used to define a point of intersection of multiple hyperboloids in 3-dimensional space. In an analogous fashion, to determine the position of a device on a plane, three range difference measurements between the Query Unit and the Responding Unit would be required for unambiguously determining the intersection of the corresponding hyperbolae. Further, in 3-dimensional space, four such range difference measurements would be required to resolve spatial ambiguity in the intersection of the corresponding hyperboloids. It is noted that increased accuracy can be achieved by adding additional Responding Units to the system 100, and averaging over the corresponding redundant set of hyperboloid intersections. For simply determining the distance between two cooperating Query and Responding Units, only two cooperating devices would be required.

In the presently disclosed embodiment, the system 100 is configured to allow a device to determine its position relative to the Responding Units 101, 102, 103, and optionally relative to a navigation grid or map coordinate system (not shown), so long as the positions of the Responding Units 101, 102, 103 are known in the desired coordinate system. For example, in some applications, information relating to a navigation grid or map coordinate system may be entered at the time of system installation. In other applications (e.g., those that include one Query Unit and at least four Responding Units), the estimated positions of the Responding Units may be broadcast in the response messages so that the group of devices as a whole can converge on precise relative positions.

As shown in FIG. 1, one or more Responding Units (such as the Responding Unit 102) may have an associated communications gateway 109, including, for example, a WIFI 110 or Ethernet interface (or both), which allows the system 100 to communicate with the outside world. The communications gateway 109 allows a user of a personal computer (PC), a personal digital assistant (PDA), or any other suitable computerized device, to interact with the system 100 for entry of the positions of the Responding Units during system installation, and/or for receipt of reports on device positions during system operation. In one embodiment, this interface may include an HTML server that permits access, via a standard browser, to information generated by the system 100.

As further shown in FIG. 1, the system 100 may include one or more passive Mobile Units 105 that do not transmit any RF signals, but receive both the query messages and the corresponding response messages. From these query-response message exchanges, the passive Mobile Unit 105 can measure the time-difference-of-arrival (TDOA) between the respective messages, since the unit 105 is aware of the predetermined delay time (Guard time) between the receipt of a query message by a Responding Unit and the subsequent transmission of a corresponding response message by that unit. As discussed above, in 3-dimensional space, four such time difference measurements would be required to resolve spatial ambiguity in the intersection of the corresponding hyperboloids. Because the passive Mobile Units do not transmit any RF signals, these units typically require less power to operate than the Query Units or the Responding Units. It is noted that, in some applications, the passive Mobile Units may be configured to transmit at a reduced bit rate to convey their respective positions to the communication gateway 109. So long as there are a total of at least three Responding Units 101, 102, 103 and a single Query Unit 104, the Responding Units 101, 102, 103, as well as the passive Mobile Unit 105, will be capable of determining their respective positions in 3-dimensional space.

It is further noted that provision may be made for redundancy of the Query Unit 104. For example, all of the units 101, 102, 103, 104 possess unique addresses, which are contained in the appropriate query messages and/or response messages. If a unit with address “n” currently acts as the Query Unit, then another unit (such as one of the Responding Units) with address “n+1” may subsequently act as the Query Unit if no query message is transmitted by the current Query Unit within a specified time-out period. In addition, to minimize the effects of geometric dilution of precision (GDOP), the role of the Query Unit may be handed-off in a cyclic fashion among the various units within the system 100, e.g., in a manner analogous to that employed by MAC protocol logic associated with a token ring network. As known in the art, GDOP is a term that is customarily used in association with location systems employing several geographically spaced transmitter/receiver units. A low dilution of precision (low DOP) value generally represents increased positional accuracy.

### Message Sequence

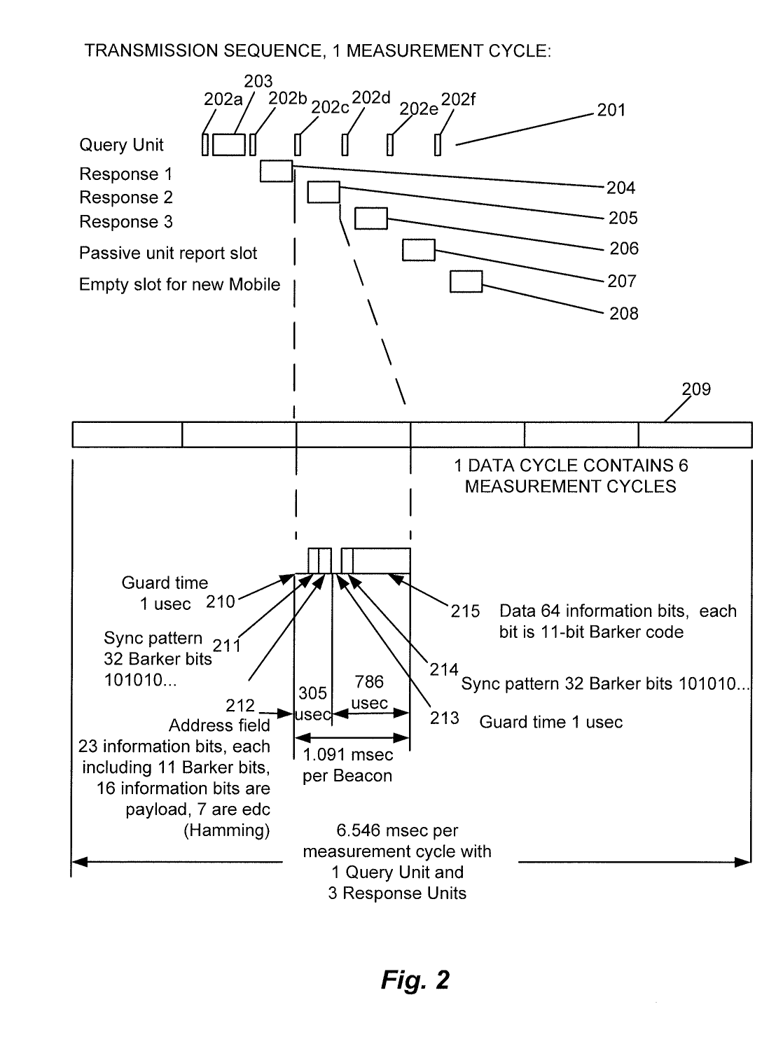

FIG. 2 depicts an illustrative sequence of query and response messages, with time progressing from left to right. At the top of FIG. 2, successive transmissions 201, 204, 205, 206 generated by a Query Unit and three Responding Units 1, 2, 3, respectively, are shown. Specifically, the transmission 201 generated by the Query Unit includes a Polling packet 202, which includes a query message 202a, followed by, after a predetermined delay time, a corresponding response message 203. This query-response message pair 202a, 203 provides a time calibration for the other units within the system, allowing them to compensate for clock drift relative to the Query Unit. The transmission 201 further includes a plurality of query messages 202b, 202c, 202d, 202e, 202f, based on the number of Responding Units within the system. These query messages 202b, 202c, 202d, 202e, 202f are spaced at regular intervals so that the corresponding response messages can occur during these respective regular intervals. For example, the Responding Unit 1 responds to the query message 202b with the response message 204, which occurs during the interval between the query messages 202b, 202c. Similarly, the Responding Unit 2 responds to the query message 202c with the response message 205, which occurs during the interval between the query messages 202c, 202d. In addition, the Responding Unit 3 responds to query message 202d with the response message 206, which occurs during the interval between the query messages 202d, 202e.

As shown in FIG. 2, a passive Mobile Unit report message slot 207 can be triggered by the query message 202e, which, in this case, acts as a polling request. It is noted that the slot 207 can be used in cyclic round-robin fashion by multiple passive Mobile Units to report their respective positions and status to the outside world via the communications gateway 109 (see FIG. 1). Similarly, an empty slot 208 for a new passive Mobile Unit may be triggered by the query message 202f, which, in this case, also acts as a polling request. Although the slot 208 is normally empty, it can be used in a contention fashion by one or more additional units joining the system.

It should be understood that the illustrative signaling sequence described above is included in one of a number of measurement cycles within one data cycle 209 (see FIG. 2). For example, in one embodiment, the data cycle 209 may include six measurement cycles, thereby allowing each of six passive Mobile Units to report on its position once every six measurement cycles. The ratio of measurement cycles per data cycle can be adjusted to suit the application, and can be controlled by the address sequence in the query messages transmitted by the Query Unit.

### Message Structure

At the bottom of FIG. 2, the contents of a single measurement cycle are illustrated in greater detail. It is noted that specific timing values and bit coding/structures are provided below for purposes of illustration, and that any other suitable timing values and bit coding/structures may be employed. Specifically, during each measurement cycle, a query message and a corresponding response message are transmitted. The query message includes a Guard time 210, followed by a synchronization preamble 211, which in turn is followed by an address field 212 containing the address of the unit that is to respond to the query message. The Guard time 210 has a duration sufficient to prevent message overlap at any point within the system's geographic range. The response message also includes a Guard time 213, followed by a synchronization preamble 214, which in turn is followed by a 64-bit data portion 215, which is described in detail below. In one embodiment, the Guard time 210, 213 is 1 μsec, the synchronization preamble 211, 214 is a 32-bit Manchester-encoded synchronization preamble, and the address field 212 is a 23-bit sequence of information bits, each including an 11-bit Barker code. The 23-bit information sequence includes 16 information bits encoded with a 23-bit Hamming code for purposes of error detection and correction (edc).

In the illustrated embodiment, the duration of the query message is about 305 μsec, the duration of the corresponding response message is about 786 μsec, and therefore the duration of the corresponding measurement cycle is about 1.091 msec. Accordingly, the duration of the data cycle 209 containing the six measurement cycles is about 6.546 msec. As described above, such a data cycle is appropriate for use in a system including one Query Unit and three Responding Units.

As further described above, the data portion 215 (also referred to herein as the “short data packet”) includes 64 information bits, of which 32 bits are a portion of a long data packet transmitted over multiple data cycles. It is noted that the length of the short data packet is limited to minimize the effect of clock drift on the time-of-arrival (TOA) measurements. The 32 bit field containing the portion of a long data packet is referred to herein as the “Portion of long packet” (see the TABLE below), and is used to transmit a 32-bit fragment of the current long data packet. In the illustrated embodiment, a long data packet transmission therefore occurs over a sequence of four short data packets.

The bit structures of the short data packet and the long data packet are described in the TABLE below.

TABLE

| | Bits - short | Bits - long |
|---|---|---|
| Field | packet | packet |
| Guard time between | 1 μsec | |
| packets | | |
| System address/house | 8 | |
| code | | |
| Source address | 8 | |
| Operation code/packet | | 16 |
| length | | |
| x-position | | 16 |
| y-position | | 16 |
| z-position | | 16 |
| time | | 16 |
| Operation code and | | 40 |
| arguments | | |
| Payload sequence number | | 8 |
| Portion of long packet | 32 | |
| CRC code | 16 | |
| Total bits | 64 | 128 |

It is noted that the “Operation code and arguments” field indicated in the foregoing TABLE will typically be application dependent, but may include query and response information about unit activities and/or command and acknowledgement information from a remote supervisory controller (not shown) acting over the Internet from any desired location. For example, the command and acknowledgement information may include commands directed to a robot or any other suitable autonomous mobile device for performing particular tasks, reports from the robot about unexpected events within its environment, and/or routine diagnostic information about the status of the robot or the overall system. In the illustrated embodiment, each of the information bits in the Operation code and arguments field includes an 11-bit Barker code.

### Physical Layer

For purposes of illustration, it is assumed that the presently disclosed system for determination of position operates in the 901-928 MHz industrial, scientific, and medical (ISM) radio band, and that modulation is implemented within the Query/Responding Units using binary phase shift keying (BPSK). In addition, each information bit contained in the address field 212 and the data portion 215 (see FIG. 2) is represented by a Barker code or its inverse. For example, an exemplary network timing analysis provided below assumes that an 11-bit Barker code is employed, specifically,
1 1 1 0 0 0 1 0 0 1 0 for a logical high or “1”, and
0 0 0 1 1 1 0 1 1 0 1 for a logical low or “0”.

It is noted that, at the expense of some error robustness and the addition of another parallel correlator logic block (not shown) in the Query/Responding Unit, a doubling of information bandwidth can be achieved by using four Barker codes, two of which are the time-reversal of the two Barker codes for “1” and “0” described above. The exemplary network timing analysis below assumes, however, that two Barker codes and one parallel correlator logic block are employed in the Query/Responding Unit, thereby allowing the generation of either a positive or negative peak correlation value.

In the presently disclosed embodiment, the receiver within the Query/Responding Unit correlates with the first Barker code. In absence of errors, the peak correlation will be +11 for a 1 bit, and −11 for a 0 bit. In addition to extracting the information bit sense, the receiver generates a time-of-arrival (TOA) measurement for each of the two Barker codes, recording its local clock value at the end of the Barker bit-generating peak correlation. The receiver can also employ a frequency hopping scheme to mitigate interference in a particular band, to allow multiple independent systems to operate within range of one another, and to reduce the effects of multi-path upon the aggregate propagation delay time measurement.

### Network Timing

The following exemplary network timing analysis, including the numerical values employed in this exemplary analysis, are provided for purposes of illustration. It should be understood that any other suitable sets of values may be chosen for different applications or frequency bands. In this exemplary analysis, the RF transmission is in the 901-928 MHz ISM band. In addition, 30:1 down conversion is performed, resulting in an intermediate frequency (IF) signal of about 30 MHz. In addition, BPSK modulation is employed with 16 IF cycles per Manchester bit, or 32 cycles per Manchester-encoded Barker bit. Thus, each Barker bit has duration of about 1.066 μsecs. Because each information bit includes 11 Barker code bits, the information bit duration is about 11.733 μsecs, and the information bit rate is about 85.229 kbps. It should be appreciated that different choices of the above parameters may be appropriate for different applications.

In this example, each query message packet starts with a Guard time of 1 μsec, followed by a synchronization preamble of 32 alternating 0 and π phases, which serve to lock a phase locked loop (PLL) that decodes the Barker bits to the phase transitions in the modulated IF wave form. The synchronization preamble is followed by a 23-bit information field, including 16 payload bits and 7 forward error correction bits, using a (16, 6) Hamming code plus parity. The duration of each query message packet is therefore about 305 μsecs (see FIG. 2). In addition, each response message packet starts with a Guard time of 1 μsec, followed by a 32-bit synchronization preamble, which in turn is followed by a 64-bit information field including a 16-bit cyclic redundancy code (CRC). A single Query-Response measurement cycle therefore lasts for about 1.091 msecs (see FIG. 2). Further, a system including one Query Unit and three Responding Units can execute a data cycle containing six measurement cycles in about 6.546 msecs (see FIG. 2). Such a system would therefore execute about 153 complete navigation cycles per second.

### Query Unit and Responding Unit Structure

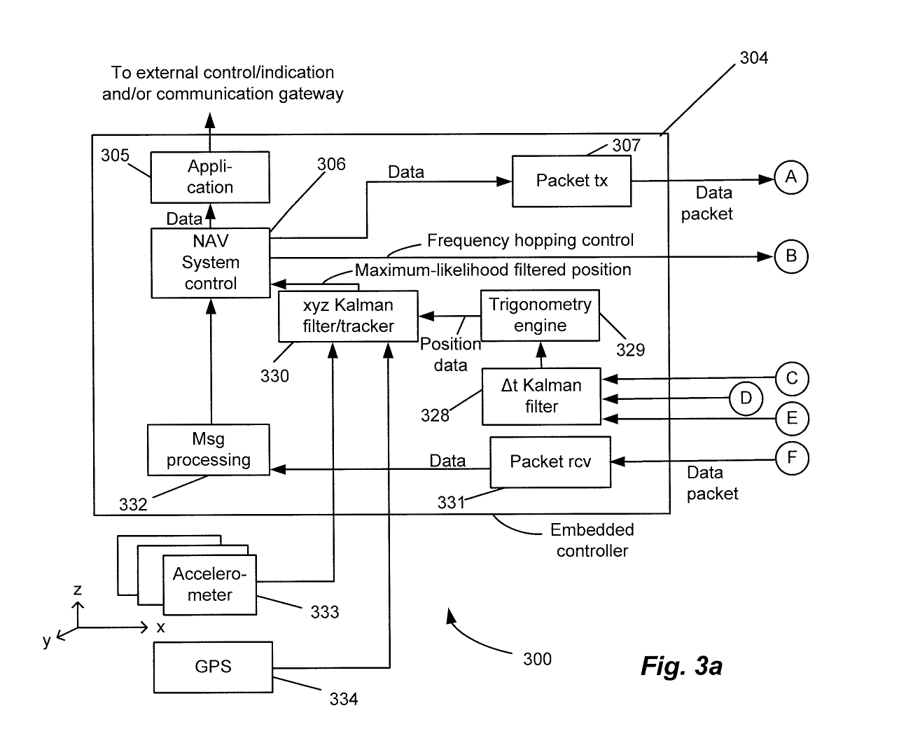

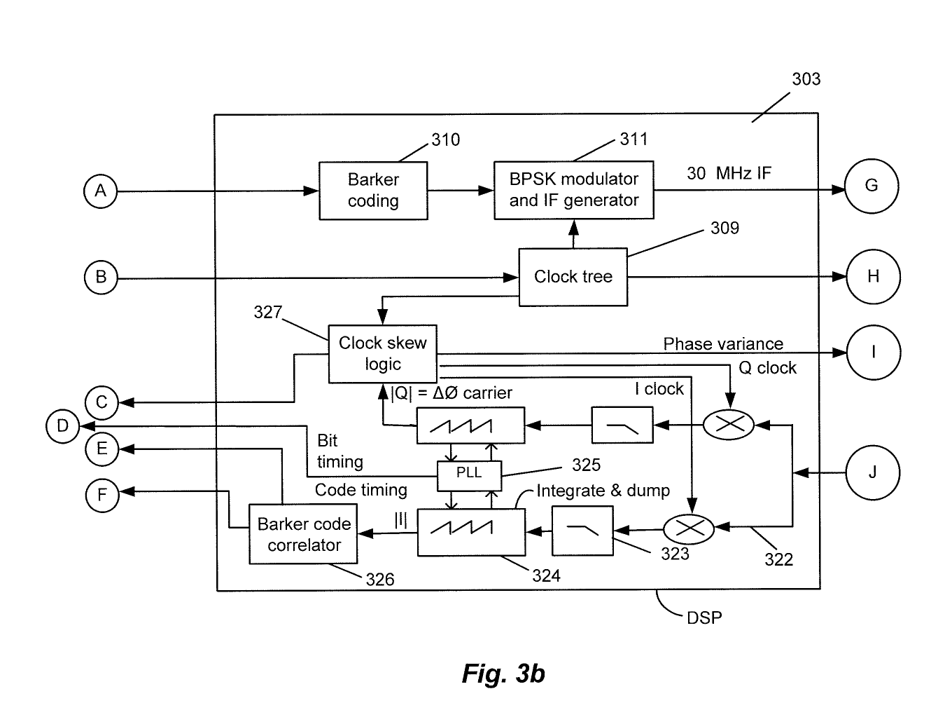

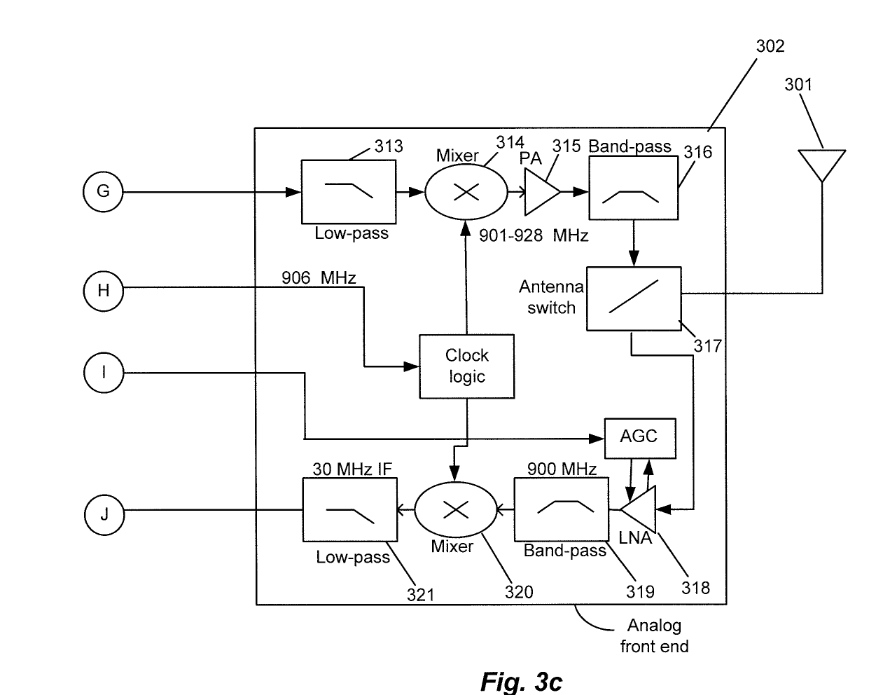

FIG. 3 depicts an illustrative embodiment of a Query or Responding Unit 300 included in the system 100 (see FIG. 1). It is understood that each Query, Responding, and passive Mobile Unit included in the system 100 can have substantially the same structure as the unit 300. As shown in FIG. 3, the Query or Responding Unit 300 includes an antenna 301 and three main functional blocks, namely, an analog front end 302, a digital signal processor (DSP) 303, and a navigation/protocol processor 304. In volume production, with the exception of a few discrete RF components and the antenna 301, these functional blocks 302, 303, 304 may be implemented within a single mixed-mode ASIC, as is common practice with 900 MHz, 2.5 GHz, and 5.5 GHz integrated radio system chips provided by major manufacturers. Further, the digital portion of the ASIC may include a mixture of digital signal processing implemented at the gate level, and sequential, software-based processing, where appropriate.

The description that follows traces the signal activity through each of the main functional blocks 302, 303, 304. Within the navigation/protocol processor 304, the Application block 305 is configured to format and feed mobile position data to a web server and WIFI interface (such as the communication gateway 109; see FIG. 1), and to report on system status, low battery levels, and/or any other conditions of interest such as those associated with the environment in which the Unit 300 is situated (e.g., in the case of unattended sensors). The Application block 305 can also be used to enter position information into the system, “House codes” for minimizing interference between neighboring systems by selecting a suitable frequency hopping sequence, unit identity information, and any operating parameters specific to the current application. In addition, the Application block 305 may act as a pass-through node to forward such information to other units in the system that are not equipped with an external interface.

The NAV System Control block 306 included in the navigation/protocol processor 304 implements the MAC layer protocol, accepts system configuration information from the Application block 305, and triggers a data packet transmission by a Packet Transmit block 307 within the processor 304 at the appropriate times, as determined by the MAC protocol and the prescribed role of the unit (i.e., query, responding, or passive). The NAV System Control block 306 also receives packet data from a Message Processing block 332 included in the processor 304, and either acts on it as required or passes it along to the Application block 305. The packet Transmit block 307 formats data packets with data supplied by the NAV System control block 306, and sends the resulting information bit sequence to the DSP 303.

Within the DSP 303, a clock tree 309 is provided based on a 1 GHz clock generated by a doubler chain, PLL multiplier, or any other suitable technique. For example, the 1 GHz clock may be generated by an external crystal that, for reduced cost, operates at a reduced frequency (e.g., in the 30 MHz range), resulting in a 1 nsec time base and a 0.25 nsec mean time quantization error (after offset for the mean one-half clock). From this primary clock, various lower frequencies can be generated using suitable counters. In this example, 1 GHz is a suitable frequency for use in a low cost ASIC. Higher frequencies, although they would improve the time quantization error, would likely increase both costs and power consumption. It is expected that higher clock frequencies, with the resultant improvement in system accuracy, will become more economical in the future as semiconductor technology continues to improve.

A Barker coding block 310 included in the DSP 303 receives a control signal and a sequence of information bits from the packet Transmit block 307. The Barker coding block 310 encodes and outputs the appropriate Barker bit sequence to a Modulator block 311 within the DSP 303. In the event the sequence of information bits corresponds to a response message, the timing of this process is determined at least in part by the expiration of a response delay counter contained in the clock tree 309, which is launched upon receipt of the corresponding query message. The code sequence is BPSK modulated by the Modulator block 311 based on a 30 MHz IF clock provided by the clock tree 309. This digitally generated IF signal is filtered by a low-pass filter 313 included in the analog front end 302, and mixed-up by a mixer 314 within the front end 302 to a frequency in the 900 MHz ISM band by multiplication with another clock frequency (e.g., 906 MHz) provided by the DSP 303. This frequency may be adjusted by command from the NAV System Control block 306 to accomplish the frequency hopping mentioned above on a bit, code, or packet basis. The analog front end 302 also includes an amplifier 315 that amplifies the signal in the 900 MHz ISM band, a band-pass filter 316 that filters the amplified signal to conform to the FCC spectral mask, and an antenna switch 317 that directs the filtered signal to the antenna 301 for subsequent transmission. Because high linearity is not required, the amplifier 315 can be implemented using a single low cost transistor.

As shown in FIG. 3, the analog front end 302 further includes an automatic gain control (AGC) block 318, a band-pass filter 319, a mixer 320, and a low-pass filter 321. In the event the unit 300 acts as a Responding Unit, an RF signal received by the antenna 301 is amplified in a low noise amplifier (LNA) stage within the AGC block 318, filtered by the band-pass filter 319, and mixed-down by the mixer 320 to 30 MHz IF. The received RF signal is then filtered by the low-pass filter 321, and provided to the DSP 303 as a hard-limited signal (1 or 0).

The DSP 303 is configured to perform a number of operations. First, the DSP 303 demodulates the incoming IF signal to generate a sequence of Manchester bits, each pair of Manchester bits representing a single Barker bit. Next, the DSP 303 correlates the code sequence to determine the sense of the Barker code, and therefore the sense of the data bit conveyed by the Barker code. The DSP 303 then determines the time-of-arrival (TOA) of the Barker code based on the clock time of the peak correlation. Next, the DSP 303 determines the code edge timing by synchronizing to the edges of the Manchester bits, using a phase locked loop (PLL) 325. In the event the code sequence corresponds to a response message, the DSP 303 measures the phase of the incoming IF signal, and compares it to the phase of the most recently received query message, modulo a fraction of the carrier cycle. Next, the DSP 303 measures the frequency offset between its local clock and the incoming IF signal. This offset or time rate of change (dØ/dt) is the sum of the relative drift between the local and transmitting clocks, and the pseudo-range rate of change (dr/dt). The steps of determining the TOAs of the Barker codes, determining the code edge timing, and measuring the phase of the incoming IF signal can be performed to obtain a measure of the times-of-arrival (TOAs) of the query message and the response message, from which a measure of the time-difference-of-arrival (TDOA) of the query and response messages can subsequently be derived. Such measures can be combined to provide a best estimate of message time-of-arrival, averaged over all of the information bits within a respective message.

It is noted that, in the illustrated embodiment, the receiver included in the Query/Responding Unit 300 is based on a heterodyne complex (I-Q) architecture. Specifically, the incoming IF signal is multiplied separately by in-phase (I) and quadrature-phase (Q) clocks in a complex mixer 322 included in the DSP 303, which further includes a low-pass filter 323 and integrate and dump logic 324. The resulting signals are filtered by the low-pass filter 323, and sent to the integrate and dump logic 324, which accumulates the received baseband energy for one Manchester bit period, latches the output value, dumps the accumulator, and then repeats the accumulating, latching, and dumping operations. The times at which the latch-and-dump operations occur are determined by the PLL 325, which synchronizes to the Manchester bit edges acting on the 0, π, 0, π, 0, π, 0, π phase sequence contained in the synchronization preamble of each message.

The integrate and dump logic 324 provides the |I| and |Q| magnitudes as outputs, which are subsequently used as follows. First, the sign of the I component is used to determine the Barker bit sense, 1 or 0, which is fed to a sliding window Barker code correlator 326 within the DSP 303 to decode the current information bit. Second, the magnitude of the Q signal is used as a measure of the offset of the receipt alignment from 0 and π radians, which in turn is used as input to clock skew logic 327 within the DSP 303. The clock skew logic 327 is configured to minimize |Q| by skewing the I and Q clocks sent to the complex mixer 322. The skew rate is a measure of clock drift between the transmitting and receiving units plus Doppler shift. The magnitude of the shift required from the previous local clock phase during the synchronization preamble is a measure of the phase shift of the IF signal, in fractions of a wavelength, between the local clock and the remote transmitting clock. It is noted that for most applications of interest, with unit velocities typically in the low tens of feet per second and frequencies in the 900 MHz ISM band, the Doppler shift will be insignificant. In the event of receipt of a response message, the previous local clock phase would be determined by the most recent query message, and therefore this shift would represent a measure of the time-difference-of-arrival (TDOA) between the query message and the response message expressed as a fraction of an IF cycle (e.g., 30 MHz). Because the IF signal was generated by multiplication of the local clock with the incoming carrier, this shift is also a measure of the phase shift of the carrier, if both are expressed in radians.

In addition, the clock skew logic 327 measures the variance of the individual phase measurements, and executes a hill-climbing optimization algorithm to adjust the gain of the AGC block 318. For any received signal strength and signal-to-noise ratio (SNR), there is a particular gain (or limited range of gains) that will provide the most accurate measurement of phase. Too high a gain will bring more noise energy above the receiver's threshold. For noise predominantly at frequencies higher than the carrier, this will result in spurious zero-crossings. For noise predominantly at frequencies lower than the carrier, the result will be loss of the carrier for multiple carrier cycles when the composite signal is above the clipping point, whereas at a lower gain, where the signal is in the linear range, the carrier would be recovered by the band-pass filtering that follows the AGC stage. Conversely, too low a gain will also result in lost transitions as the carrier drops below the receive threshold.

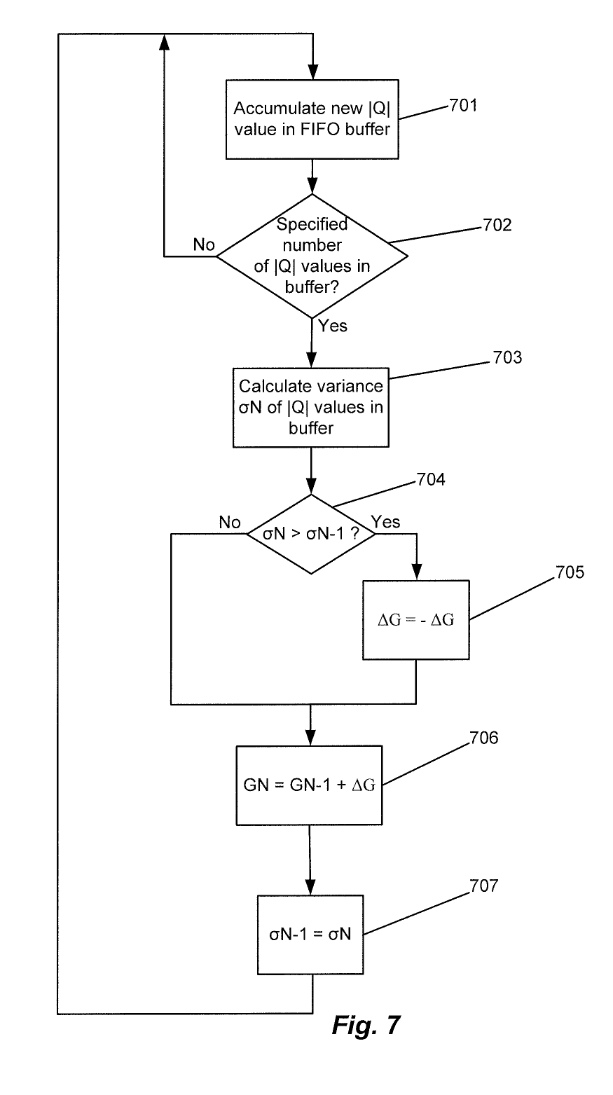

The process described below with reference to FIG. 7 is used to control the set-point of the AGC block 318, thereby allowing the AGC block 318 to produce a gain-controlled output signal from an input signal in accordance with a calculated gain control (G_{N}) value. In this exemplary process, the variance σ_{N} of a set of any suitable number of the most recent zero-crossing intervals (each representing a half-cycle of the carrier) may be calculated by accumulating the individual values (either from the |Q| value or the clock time of transitions in the level of the saturated carrier entering the I-Q detector) in a FIFO buffer within the clock skew logic 327, and computing a phase variance. In each execution of the optimization loop depicted in FIG. 7, a new value of |Q| is accumulated in the FIFO buffer (see step 701), and the oldest value of |Q| is dropped from the buffer. Then, after a specified number of new values of |Q| have been accumulated in the buffer (see step 702), a new variance (σ_{N}) of |Q| is calculated (see step 703). If the new value σ_{N} is greater than the previous variance (σ_{N-1}) value (as determined in step 704), the sign of a gain-change increment ΔG value is reversed (see step 705). Then, the gain control (G_{N}) value is changed by Δ_{G} (see step 706). Next, the previous σ_{N-1} value is set to the new value σ_{N} (see step 707). This process is then repeated with each new |Q| measurement, or with each several such measurements. With the appropriate choice of gain adjustment period and magnitude of ΔG, this will lead the AGC stage to a G_{N} value producing a low variance σ_{N} in |Q|. If the noise statistics and received signal strength are stationary in time, then the gain will dither between two values. When the signal or noise spectrum changes, the hill-climbing optimization algorithm will track to the new optimal range. Depending on the characteristics of the AGC loop, different values of loop gain equal to [σ_{N}−σ_{N-1}]/ΔG, as well as inclusion of integral and differential terms may be appropriate, following customary control system design practice.

It is further noted that the PLL 325 (whose function is to track and report the difference between the times of the zero-crossings of the received signal and the times at which they might have been expected based on the unit's local clock) may employ similar logic to that shown in FIG. 7, alone or in combination with a more customary phase locked loop (PLL), for the purpose of maintaining the clock offset value needed to track the incoming Manchester transitions. Simultaneously with the processing of the clock skew logic 327, the sequence of codes is shifted through the Barker code correlator 326, which compares each bit in its shift register with the corresponding bit of a reference code, and captures the time of peak correlation. The sign of the peak correlation, which signifies the sense of the current information bit, is then fed to the navigation/protocol processor 304.

As shown in FIG. 3, the navigation/protocol processor 304 includes a Δt Kalman filter 328, a trigonometry engine 329, an xyz Kalman filter/tracker 330, a packet receive block 331, and a message processing engine block 332. The TDOA data for each query-response transaction is passed to the Δt Kalman filter 328, which generates a maximum likelihood estimate and passes the result to the trigonometry engine 329. This Kalman filter 328 combines the Barker code synchronization time generated by the correlator 326, the bit timing from the PLL 325 dump triggers, and the clock skew logic 327 timing in a single estimate incorporating the coarse, medium, and fine resolution of these respective measures. This process has the advantage of removing the wavelength ambiguity that would result from simply measuring phase. Next, the trigonometry engine 329 performs the calculations necessary to determine the intersection of the corresponding hyperboloids, and sends the results to the Kalman filter/tracker 330, which operates in 3-dimensional geometric space to estimate the device position. This filter/tracker 330 contains a kinematic model of unit position, velocity, and acceleration, and combines the expected position of the unit based on its past position, velocity, and acceleration, with the position delivered by the most recent TDOA ranging cycle. These two measures are combined in a maximum-likelihood estimate, following any suitable Kalman filter-based target tracking algorithm.

In order to mitigate the effects of multipath, the Kalman filter/tracker 330 may accept additional inputs from external accelerometers 333 in two or three axes, which inputs can provide the basis for inertial navigation, determining position as the second integral of acceleration. Using any suitable method for the fusion of inertial guidance with GPS positioning, the Kalman filter 330 may contain in its state vector both the accelerometer inputs and the TDOA inputs. The system will weight these two sources of information according to their respective variances, and provide a combined estimate of position. In many cases, the use of MEMS-based accelerometers will be suitable because of their low cost. Although not sensitive enough for un-aided accurate inertial navigation, their information will mitigate the errors due to multipath, which will tend to create sudden shifts in apparent position as a mobile unit moves into or out of a region where a strong reflected path is present. If the corresponding high acceleration is not corroborated by the accelerometers, then the navigation output will weight the inertial inputs more strongly. An alternative realization might use a Global Positioning System (GPS) 334 instead of the accelerometers 333 as an input, and, in a similar fashion, fuse the GPS information with that from the local navigation grid. In the case where each of the units 101-105 (see FIG. 1) is equipped with a GPS receiver, this may function as a form of GPS enhancement, in which a number of the units 101-105 may have lost satellite reception due to shadowing or RF noise, and yet still know their position accurately because they are part of the local navigation grid. Separately, the packet receive block 331 decodes the data portion of the message packet, checks the CRC error detection code, and passes the results to the message processing engine block 332, which in turn provides the appropriate information to the navigation system control block 306.

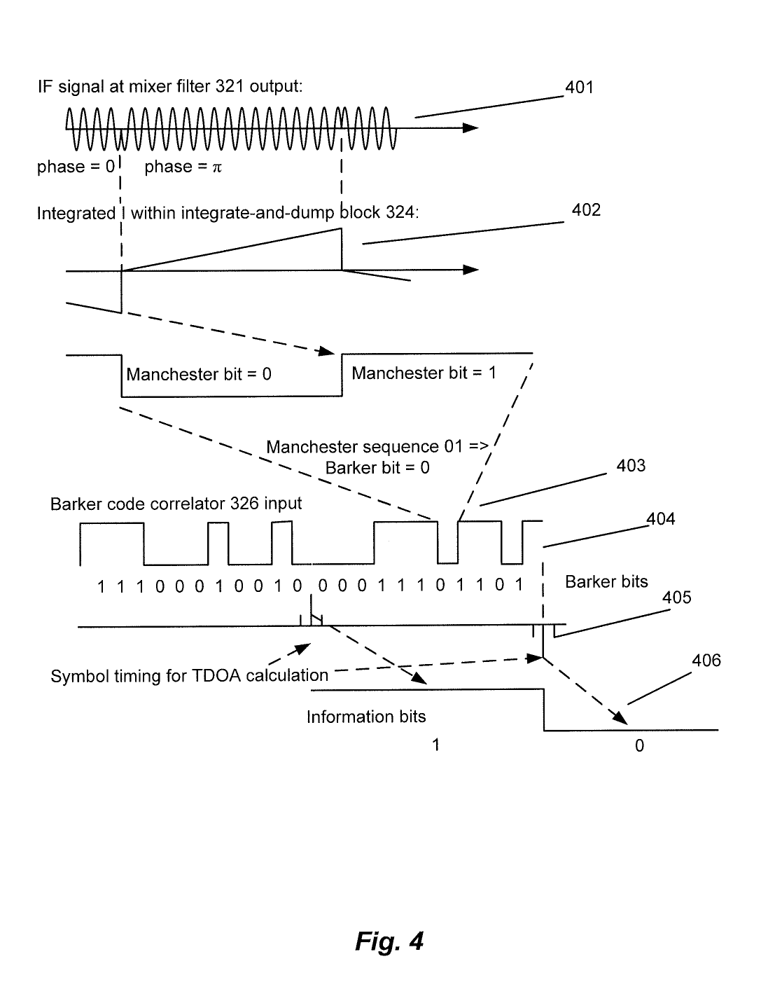

FIG. 4 depicts the incoming IF signal processed by the Query/Responding Unit 300 (see FIG. 3) at various points in the receive chain. Specifically, a bi-phase modulated IF signal 401 is provided at the output of the low-pass filter 321 (see FIG. 3). Next, the IF signal 401 is hard-limited to a string of 1's and 0's in the DSP 303 (see FIG. 3). The 1's and 0's are then separated into in-phase (I) and quadrature-phase (Q) components by multiplication with the corresponding reference clocks I, Q. The in-phase component (I) will be a “1” when the incoming phase is 0 relative to the local clock, and a “−1” when the incoming phase is π relative to the local clock. Next, the integrate-and-dump block 324 (see FIG. 3) accumulates these positive or negative values until the end of the bit period, as illustrated by a ramp 402, at which time the value is dumped. The integrate-and-dump block 324 then determines the value of the Manchester bit (0 or 1). A pair of Manchester bits (0, 1 or 1, 0) determines whether the value of the corresponding Barker bit is 1 or 0, as illustrated by an exemplary input 403 to the Barker code correlator 326 (see FIG. 3). Next, after all of the bits of the Barker code have been shifted-in, the correlator 326 generates a positive or negative peak correlation 405, resulting in a 1 or 0 value of the corresponding information bit, as illustrated by a binary signal 406. The local clock time at which the peak of the code correlation occurs is then recorded and used in the TDOA calculation.

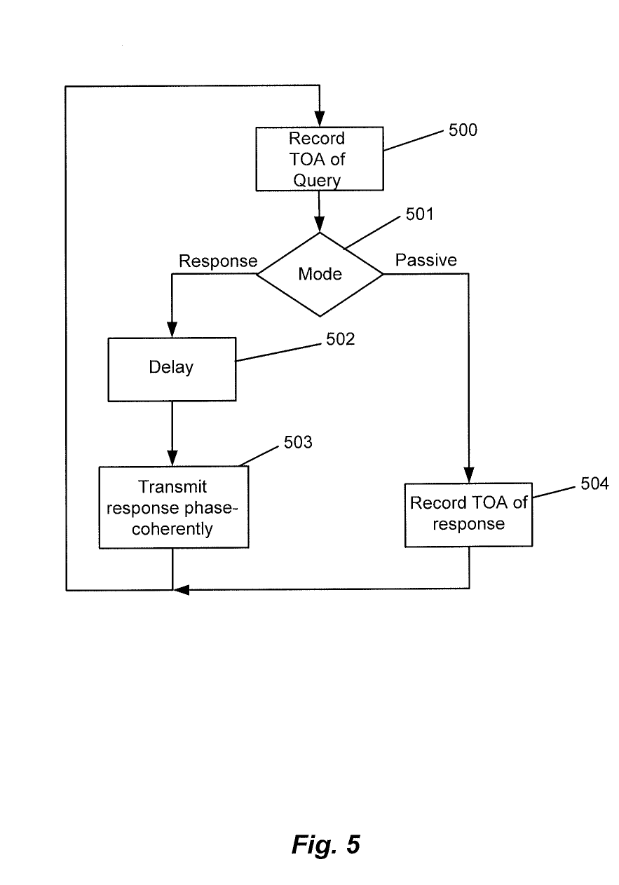

The propagation delay time processing is further described below with reference to FIG. 5. As depicted in step 500, the time-of-arrival (TOA) of each Barker code in a query or response message packet is recorded. When the preamble sequence of Manchester bits “101010 . . . ” is detected, the phase will be arbitrary, containing nonzero I and Q components. The clock skew logic 327 (see FIG. 3) inserts a time-shift in the local I and Q clocks such that |Q| equals 0, and |I| is at a maximum. As the message is received, this adjustment is made continuously, and the relative drift d(ΔØ)/dt is recorded. The bit-clock of the correlator 326 (see FIG. 3) is driven by, and therefore synchronized to, the Manchester bit clock PLL 325 (see FIG. 3), thereby maintaining phase coherence. The individual times of correlation peaks are processed by the Kalman filter 328, which takes into account the predicted time of each peak based on the known timing of transmitted bits, the clock drift measured at the IF phase level, and the actual arrival time of the peaks. A maximum likelihood estimate of the message packet arrival time is then provided at the output of the Kalman filter 328.

Next, as depicted in step 501, a determination is made as to whether the unit (i.e., the Query/Responding Unit 300; see FIG. 3) is operating in the query mode, the responding mode, or the passive mode. This determination can be made by determining whether or not the address code contained in the query message matches that of the unit. If the address code matches that of the unit (i.e., the unit is operating in the responding mode), then the unit implements, as depicted in step 502, a delay of 1 μsec or any other suitable delay. In this example, the delay of 1 μsec results in a 1000 foot range difference, which is a limiting factor on the range of the system. It should be understood, however, that this range difference can be increased. Next, as depicted in step 503, the unit generates a response message. The internal clock used to generate the carrier is adjusted to achieve phase-coherency with the carrier received from the Query Unit, taking into account the relative drift rate extrapolated during the intervening time delay.

Otherwise, if the address code does not match that of the unit (or if the unit is operating in the passive mode, or if the unit corresponds to the Query Unit that generated the query message packet), then the unit simply waits for the corresponding response message to arrive, and records the time-of-arrival (TOA) of the response message, as depicted in step 504. The TOA of the response message is determined by the adjustment of phase as a result of the synchronization preamble and Kalman-filtering of successive Barker correlation peaks, taking the relative drift into account, as described above.

The difference between the time-of-arrival (TOA) of the query message and the time-of-arrival (TOA) of the corresponding response message defines a time-difference-of-arrival (TDOA) that corresponds to the range difference between the Query Unit and the Responding Unit. This TDOA value is passed to the trigonometry engine 329 (see FIG. 3), which calculates the corresponding hyperbola and optionally overlays it with the time differences to other units. The intersections of such hyperbolae, by pair, are then provided to the xyz Kalman filter/tracker 330, which generates a position value in Cartesian coordinates or any other suitable coordinates that is updated for each successive set of TDOA values. In one embodiment, the model employed by this filter 330 is based on the device position resulting from extrapolated velocity from a previous device position, the most recent position measurement, and/or the dispersion of hyperbola/hyperboloid intersections corresponding to the current measurement cycle and any previous cycles. This generally follows practices for radar tracking algorithms, but is further extended as follows, in accordance with the present invention. A change in weighting for a particular intersection is incorporated into the Kalman model, depending on whether the underlying TOA measurements have increased or decreased beyond a specified threshold (a sudden increase is likely due to the onset of multi-path effects, while a sudden decrease is likely due to a lessening of multi-path effects), and a lowered weighting for a particular intersection is incorporated into the Kalman model in the event that an unrealistic magnitude of device acceleration was observed during the last sampling interval.

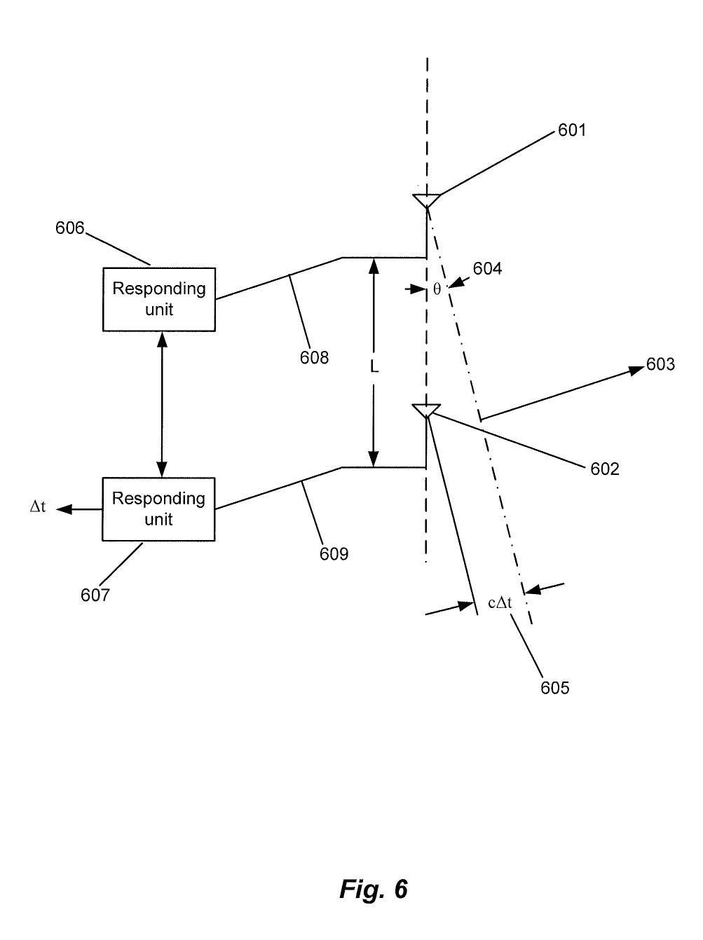

An array of two or more receivers included in two or more Responding Units can be linked to generate a bearing in azimuth and/or elevation to the currently transmitting (Query or Responding) Unit. For example, FIG. 6 depicts a pair of antennas 601, 602 separated by a distance L, each receiving a signal from a relatively distant Query Unit (not shown) from a direction 603. The wave-front of the transmission intersects the baseline connecting the two antennas 601, 602 at an angle θ 604 such that the time delay between its arrival at the antenna 601 and at the antenna 602 is Δt, corresponding to a distance cΔt 605. Using any suitable radar technique, if accurately measured, this time delay may be converted to a bearing angle. The measurement can be performed by using two linked Responding Units 606, 607, in which each is like the Query/Responding Unit 300 (see FIG. 3). The Responding Units 606, 607 are connected to the antennas 601, 602 by cables 608, 609, respectively. In this example, the cables 608, 609 have the same length and propagation characteristics. The two Responding Units 606, 607 are co-located and operate with a common clock so that the time-difference-of-arrival (TDOA) values generated by each unit may be determined. Accuracy of the bearing measurement may be improved by using additional antennas and including their Δt measurements in the calculation. For example, in one embodiment, an array of four antennas may be disposed at the corners of a horizontal square, allowing six TDOAs to be determined and used in the azimuth calculation. Such an array, in addition to providing improved accuracy, provides the further advantage of reducing the effects of multi-path, so long as the antenna spacing L is greater than or equal to the wavelength λ of the transmitted signal. In general, the multiple antennas, taken together, operate as a synthetic aperture antenna for the system.

Having described the above illustrative embodiments, other alternative embodiments or variations may be made. For example, within the presently disclosed system, one or more passive Mobile Units may be queried, and may subsequently report on their respective positions to an external supervisory functional block (not shown). Alternatively, a Mobile Unit may be configured to perform querying operations, and to calculate TOA values as well as TDOA values.

In another alternative embodiment, the system may not include any Query Units at all. In such an embodiment, each Responding Unit may transmit a message after another Responding Unit with the preceding address has transmitted its message. This embodiment would likely require a higher cost clock with less drift to achieve the same accuracy, but would increase the rate at which measurements can be made and hence the accuracy of the averaged result over time.

In still another alternative embodiment, the system may include a single Query Unit and a single Responding Unit for the purpose of determining range only, for example, for guidance in the docking of cooperating devices.

In yet another alternative embodiment, any of the above described embodiments may be configured to determine the bearing angle to one or more Mobile Units by using measurements obtained via an antenna array.

In addition, it was described that the time interval between the detection of a query message and the detection of a corresponding response message at a passive Mobile Unit differs from a predetermined Guard time within the query and response messages by an amount representing the range difference between the Query Unit and the Responding Unit relative to the passive Mobile Unit. In an alternative embodiment, the computation of the position of the passive Mobile Unit may be based on the propagation delay times associated with multiple independent response messages, or multiple pairs of response messages.

In addition, it was described that the Query Unit broadcasts a sequence of space-time-compressed (STC) digital codes, in which each STC code may be an 11 or 13 bit Barker code or its inversion. It is appreciated that, for a given available bandwidth, the length of the STC codes can be selected to achieve a desired information bit rate and to optimize system timing accuracy, which generally increases with increasing code length. It is noted, however, that as the code length is increased, the number of independent code arrivals that are averaged into each range measurement typically decreases, thereby at least partially offsetting the improvement in system accuracy.

In the presently disclosed embodiment, RF communication is employed in the 900 MHz ISM band. It should be understood, however, that any other suitable frequencies and/or media may be employed. For example, with a suitable choice of frequencies, an alternative embodiment may employ a carrier signal using radiated, non-coherent light of modulated amplitude.

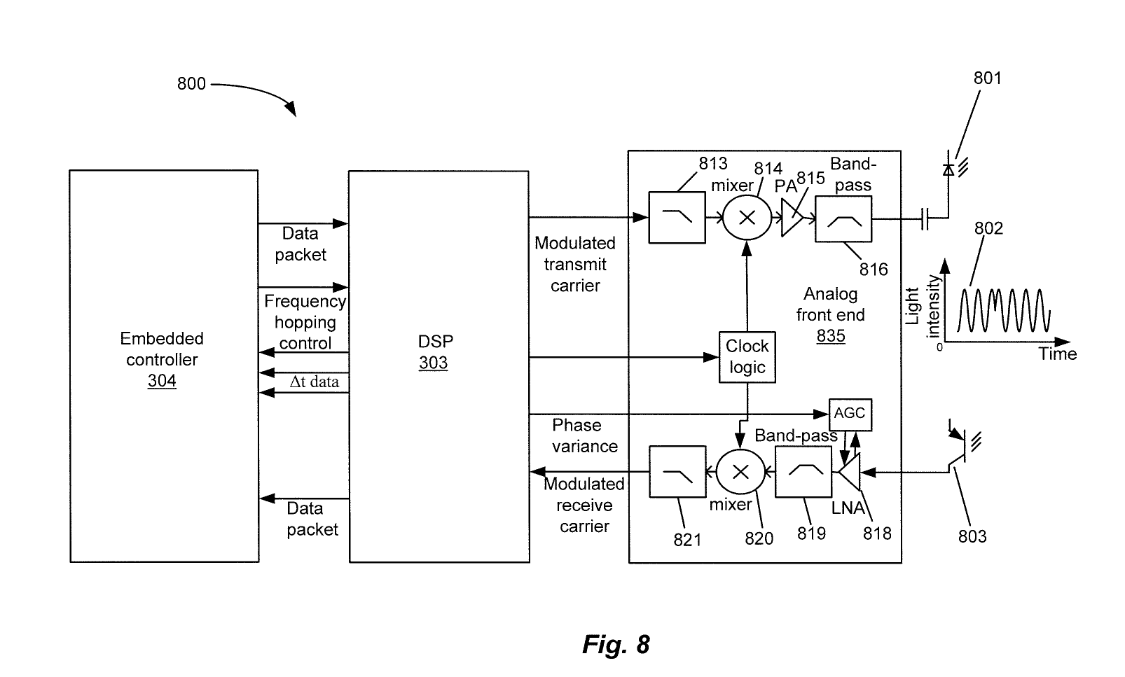

FIG. 8 depicts an illustrative embodiment of a Query or Responding Unit 800 employing a carrier signal using radiated, non-coherent, infra-red (IR) or visible light radiation of modulated amplitude. The Query or Responding Unit 800 includes an analog front end 835, the DSP 303, and the embedded controller 304 (see also FIG. 3). Within the Query or Responding Unit 800, the DSP 303 and the embedded controller 304 are configured to operate as described above, however a different frequency may be employed since FCC spectrum limitations do not apply. Moreover, the analog front end 835 is configured to operate in substantially the same manner as the analog front end 302 (see FIG. 3), but with the antenna 301 and the antenna switch 317 replaced by an array of LEDs 801 whose intensity is modulated at the carrier frequency, and with a receiving circuit driven by one or more photo-transistors or photo-diodes 803. Such a carrier signal may then be phase-modulated, as described above. It is noted that the output of the power amplifier 815 is level-shifted in such a way that the intensity of radiated light from the LED array 801 is sinusoidal with time, and is phase modulated, as illustrated in the graph 802. The photo-transistor or photo-diode 803, or an array of such devices, in the receiver creates a voltage following the light intensity 802. This voltage is fed to the front end elements 818-821, which operate as described above with reference to the corresponding elements 318-321 depicted in FIG. 3.

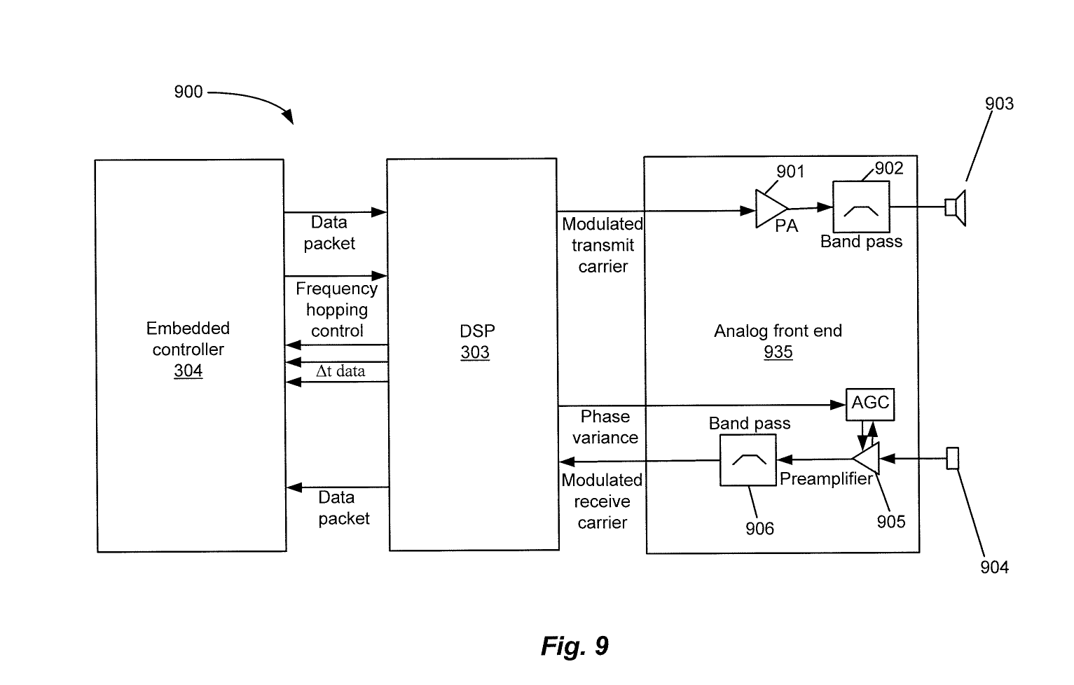

Another alternative embodiment may be configured to operate at a lower carrier frequency with acoustic signaling in either air or water, by substitution of suitable acoustic transducers for the antenna 301 and the analog front end 302. FIG. 9 depicts an illustrative embodiment of such a Query or Responding Unit 900 that operates with acoustic signaling. The Query or Responding Unit 900 includes an analog front end 935, the DSP 303, and the embedded controller 304 (see also FIG. 3). Within the Query or Responding Unit 900, the DSP 303 and the embedded controller 304 are configured to operate as described above, with the exception that the carrier frequency is in the range of 10-100 KHz in order to support efficient sound propagation in the medium. In this alternative embodiment, the unit 900 operates at baseband without the need for up-conversion and down-conversion. The modulated carrier is fed to a power amplifier 901 and a band pass filter 902, which drive an acoustic transducer 903. A microphone or other suitable transducer 904 receives an acoustic signal, which is passed to a preamplifier 905, a band pass filter 906, and then to the DSP 303, where it is processed in the manner described above with reference to the unit 300 of FIG. 3.

It will be appreciated by those of ordinary skill in the art that modifications to and variations of the above-described system and method for determination of position may be made without departing from the inventive concepts disclosed herein. Accordingly, the invention should not be viewed as limited except as by the scope and spirit of the appended claims.

What is claimed is:

1. A system for determining a position of a wireless device of a user, comprising:
a plurality of wireless devices, said plurality of wireless devices including said wireless device of said user and one or more remote wireless devices, each of said one or more remote wireless devices being disposed at a determinable position,
wherein each of said one or more remote wireless devices is operative to transmit at least one wireless signal comprising at least one code sequence, each of said at least one code sequence including a plurality of digital codes, and
wherein said wireless device of said user is operative to receive said at least one wireless signal comprising said at least one code sequence transmitted by each of said one or more remote wireless devices, said wireless device of said user including at least one processor operative:
to correlate said plurality of digital codes in each code sequence with a reference code to determine a peak correlation time for each of said plurality of digital codes in the respective code sequence;
to filter the peak correlation times for said plurality of digital codes in each code sequence; and
to perform, using the filtered peak correlation times for said plurality of digital codes in each code sequence, a time-of-arrival (TOA) calculation for the respective code sequence, the TOA calculations for the respective code sequences being used to determine said position of said wireless device of said user.

2. The system of claim 1:
wherein said wireless device of said user is further operative to transmit at least one wireless signal comprising at least one first code sequence, each of said at least one first code sequence including a first plurality of digital codes and being directed to a respective one of said one or more remote wireless devices;
wherein said code sequence transmitted by each of said one or more remote wireless devices is referred to as a second code sequence, the plurality of digital codes included in each second code sequence being referred to as a second plurality of digital codes; and
wherein each second code sequence is transmitted by a respective one of the remote wireless devices in response to receipt of the first code sequence directed to the respective remote wireless device.

3. The system of claim 2 wherein each of the remote wireless devices includes at least one processor operative:
to correlate said first plurality of digital codes in the respective first code sequence with a reference code to determine a peak correlation time for each of said first plurality of digital codes in the respective first code sequence;
to filter the peak correlation times for said first plurality of digital codes in the respective first code sequence; and
to perform, using the filtered peak correlation times for said first plurality of digital codes in the respective first code sequence, a time-of-arrival (TOA) calculation for the respective first code sequence,
whereby the TOA calculations for the respective first code sequences are used by said one or more remote wireless devices to determine times for transmitting the second code sequences.

4. The system of claim 2 wherein two or more of the remote wireless devices are co-located, the co-located remote wireless devices being operative to generate, from said at least one wireless signal transmitted by said wireless device of said user, an indication of a bearing in one or more of an azimuth and an elevation to said wireless device of said user, said bearing being used to determine said position of said wireless device of said user.

5. The system of claim 1 wherein said at least one processor included in said wireless device of said user is further operative to perform, using the filtered peak correlation times for said plurality of digital codes in each code sequence, at least one time-difference-of-arrival (TDOA) calculation for the respective code sequences, the TOA and TDOA calculations for the respective code sequences being used to determine said position of said wireless device of said user.

6. The system of claim 1 wherein each of said plurality of digital codes included in each code sequence is a space-time-compressed (STC) digital code.

7. The system of claim 6 wherein each STC digital code is a Barker code.

8. The system of claim 7 wherein said Barker code has a corresponding sense defining a logical value of an information bit within the respective code sequence.

9. The system of claim 8 wherein said at least one processor included in said wireless device of said user is operative as a sliding window correlator for decoding each of the information bits within the respective code sequence.

10. The system of claim 8 wherein the information bits within the respective code sequence include a first number of information bits corresponding to a short data packet transmitted over a single cycle of system operation, and a second number of information bits corresponding to a long data packet transmitted over multiple cycles of system operation.

11. The system of claim 8 wherein the information bits within the respective code sequence are operative to convey information regarding one or more of:
at least one activity of at least one of said plurality of wireless devices;
at least one command transmitted to at least one apparatus associated with at least one of said plurality of wireless devices;
at least one acknowledgement transmitted by said at least one apparatus associated with at least one of said plurality of wireless devices in response to said at least one command; and
a status or sensor input associated with one or more of at least one of said plurality of wireless devices and said at least one apparatus associated with at least one of said plurality of wireless devices.

12. The system of claim 11 wherein said at least one apparatus associated with at least one of said plurality of wireless devices is at least one autonomous mobile device.

13. The system of claim 1:
wherein said one or more remote wireless devices includes at least one query device and one or more responding devices;
wherein each of said at least one code sequence transmitted by said at least one query device is referred to as a first code sequence, the plurality of digital codes included in said first code sequence being referred to as a first plurality of digital codes;
wherein the code sequence transmitted by each of said one or more responding devices is referred to as a second code sequence, the plurality of digital codes included in said second code sequence being referred to as a second plurality of digital codes;
wherein each first code sequence transmitted by said at least one query device is directed to a respective one of said one or more responding devices; and
wherein each second code sequence is transmitted by a respective one of said one or more responding devices in response to receipt of the first code sequence directed to the respective responding device.

14. The system of claim 13 wherein said at least one processor included in said wireless device of said user is further operative:
to correlate said first plurality of digital codes in each first code sequence with said reference code to determine a peak correlation time for each of said first plurality of digital codes in the respective first code sequence;
to filter the peak correlation times for said first plurality of digital codes in each first code sequence;
to correlate said second plurality of digital codes in each second code sequence with said reference code to determine a peak correlation time for each of said second plurality of digital codes in the respective second code sequence;
to filter the peak correlation times for said second plurality of digital codes in each second code sequence; and
to perform, using the filtered peak correlation times for said first and second pluralities of digital codes in the first and second code sequences, one or more time-of-arrival (TOA) calculations and one or more time-difference-of-arrival (TDOA) calculations for the respective first and second code sequences, the TOA and TDOA calculations for the respective first and second code sequences being used to determine said position of said wireless device of said user.

15. The system of claim 13 wherein said at least one query device is one of at least one stationary wireless device and at least one mobile wireless device.

16. The system of claim 13 wherein each of said one or more responding devices is one of a stationary wireless device and a mobile wireless device.

17. The system of claim 13:
wherein said at least one processor included in said wireless device of said user is further operative to generate, from said at least one wireless signal, at least one quadrature-phase (Q) signal, the Q signal having an associated magnitude representing an offset of receipt alignment of said first code sequence transmitted by the query device and said second code sequence transmitted by said one or more responding devices; and
wherein said at least one processor included in said wireless device of said user is further operative to perform, using the magnitude associated with said at least one Q signal, at least one time-difference-of-arrival (TDOA) calculation for the respective first and second code sequences, the TDOA calculation for the respective first and second code sequences being used to determine said position of said wireless device of said user.

18. The system of claim 13 wherein each of said plurality of digital codes included in each code sequence is a Barker code, said Barker code having a corresponding sense defining a logical value of an information bit within the respective code sequence, and wherein said at least one processor included in said wireless device of said user is further operative:
to generate, from said at least one wireless signal, at least one in-phase (I) signal, the I signal having an associated sign; and
to determine, using the sign associated with said at least one I signal, the sense corresponding to said Barker code.

19. The system of claim 13 wherein said at least one query device comprises a plurality of query devices, said plurality of query devices being operative to transmit the at least one first code sequence to said one or more responding devices in a cyclic manner.

20. The system of claim 1 wherein one or more of said remote wireless devices is operative to use a predetermined frequency hopping technique during transmission of said at least one code sequence.

21. The system of claim 1 wherein said at least one processor included in said wireless device of said user is operative as at least one Kalman filter for filtering the peak correlation times for said plurality of digital codes in each code sequence.

22. The system of claim 1 wherein each of said one or more remote wireless devices is further operative to modulate said at least one wireless signal prior to transmission.

23. The system of claim 22 wherein each of said one or more remote wireless devices is further operative to modulate said at least one wireless signal using binary phase shift keying (BPSK).

24. The system of claim 22 wherein said at least one processor included in said wireless device of said user is further operative to demodulate said at least one wireless signal using a predetermined I-Q demodulation technique.

25. The system of claim 1:
wherein said wireless device of said user further includes one or more accelerometers, said one or more accelerometers being operative to generate acceleration data relative to at least one axis; and
wherein said at least one processor included in said wireless device of said user is further operative to perform at least one position calculation using said acceleration data generated by said one or more accelerometers, one or more of said at least one position calculation and the TOA calculations being used to determine said position of said wireless device of said user.

26. The system of claim 25 wherein each of said one or more accelerometers is a micro-electro-mechanical system (MEMS) based accelerometer.

27. The system of claim 1 further including at least one communications gateway, said at least one communications gateway being communicably coupled to one or more of said wireless device of said user and said one or more remote wireless devices, said at least one communications gateway being operative to perform one or more of:
receiving, from a user computer, one or more indications of the determinable positions of said one or more remote wireless devices; and
providing, to said user computer, at least one report on one or more of a position and a status of one or more of said wireless device of said user and said one or more remote wireless devices.

28. The system of claim 1:
wherein said wireless device of said user is further operative to receive, from a global positioning system (GPS), position data for said wireless device of said user; and
wherein said at least one processor included in said wireless device of said user is further operative to perform at least one position calculation using said position data received from said GPS, one or more of said at least one position calculation and the TOA calculations being used to determine said position of said wireless device of said user.

29. The system of claim 28 wherein one or more of said at least one position calculation and the TOA calculations are used to determine said position of said wireless device of said user relative to one or more of a predefined navigation grid and a predefined map coordinate system.

30. The system of claim 1 wherein said at least one wireless signal is a radio frequency (RF) signal.

31. The system of claim 1 wherein each of said one or more remote wireless devices is operative to transmit said at least one wireless signal using amplitude-modulated, non-coherent, infra-red (IR) or visible light radiation as a carrier signal.

32. The system of claim 1 wherein said at least one wireless signal is an acoustic signal.

33. A method of determining a position of a wireless device of a user, comprising the steps of:
providing a plurality of wireless devices, said plurality of wireless devices including said wireless device of said user and one or more remote wireless devices, each of said one or more remote wireless devices being disposed at a determinable position, said wireless device of said user including at least one processor;
in a first transmitting step, transmitting, by each of said one or more remote wireless devices, at least one wireless signal comprising at least one code sequence, each of said at least one code sequence including a plurality of digital codes;
receiving, by said wireless device of said user, said at least one wireless signal comprising said at least one code sequence transmitted by each of said one or more remote wireless devices;
correlating, by said at least one processor included in said wireless device of said user, said plurality of digital codes in each code sequence with a reference code to determine a peak correlation time for each of said plurality of digital codes in the respective code sequence;
filtering, by said at least one processor included in said wireless device of said user, the peak correlation times for said plurality of digital codes in each code sequence; and
in a performing step, performing, by said at least one processor included in said wireless device of said user using the filtered peak correlation times for said plurality of digital codes in each code sequence, a time-of-arrival (TOA) calculation for the respective code sequence, the TOA calculations for the respective code sequences being used to determine said position of said wireless device of said user.

34. The method of claim 33:
further including, in a second transmitting step, transmitting, by said wireless device of said user, at least one wireless signal comprising at least one first code sequence, each of said at least one first code sequence including a first plurality of digital codes and being directed to a respective one of said one or more remote wireless devices;
wherein said code sequence transmitted in said first transmitting step by each of said one or more remote wireless devices is referred to as a second code sequence, the plurality of digital codes included in each second code sequence being referred to as a second plurality of digital codes; and
wherein each second code sequence is transmitted in said first transmitting step by a respective one of the remote wireless devices in response to receipt of the first code sequence directed to the respective remote wireless device.

35. The method of claim 33:
wherein said one or more remote wireless devices includes at least one query device and one or more responding devices;
wherein each of said at least one code sequence transmitted in said first transmitting step by said at least one query device is referred to as a first code sequence, the plurality of digital codes included in said first code sequence being referred to as a first plurality of digital codes;
wherein the code sequence transmitted in said first transmitting step by each of said one or more responding devices is referred to as a second code sequence, the plurality of digital codes included in said second code sequence being referred to as a second plurality of digital codes;
wherein each first code sequence transmitted in said first transmitting step by said at least one query device is directed to a respective one of said one or more responding devices; and
wherein each second code sequence is transmitted in said first transmitting step by a respective one of said one or more responding devices in response to receipt of the first code sequence directed to the respective responding device.

36. The method of claim 33 wherein said performing step further includes performing, using the filtered peak correlation times for said plurality of digital codes in each code sequence, at least one time-difference-of-arrival (TDOA) calculation for the respective code sequences, the TOA and TDOA calculations for the respective code sequences being used to determine said position of said wireless device of said user.

37. The method of claim 33 wherein said wireless device of said user further includes a radio frequency (RF) front end having an automatic gain control (AGC) stage, said at least one processor including at least one buffer, and further including:
generating, by said RF front end, at least one output signal from said at least one wireless signal, the output signal having an associated gain; and
in an automatic gain controlling step, automatic gain controlling, by said AGC stage, the output signal generated from the wireless signal in accordance with a gain control (G_{N}) value, the G_{N} value having an associated incremental (ΔG) value, and the ΔG value having an associated sign,
wherein said automatic gain controlling step further includes:
in a generating step, generating, from the output signal, at least one quadrature-phase (Q) signal, the Q signal having an associated magnitude (|Q|) value;
in an accumulating step, accumulating the |Q| value of the Q signal in said buffer;
in a first repeating step, repeating said generating step and said accumulating step until a specified number of |Q| values are accumulated in said buffer;
in a calculating step, in the event said specified number of |Q| values of the Q signal are accumulated in said buffer, calculating a variance (σ_{N}) of the |Q| values accumulated in said buffer;
in a reversing step, in the event the calculated variance σ_{N} is greater than a previous variance (σ_{N-1}), reversing the sign of the ΔG value;
in an adding step, adding the ΔG value to a previous gain control (G_{N-1}) value to obtain the G_{N} value; and
in a controlling step, controlling, by said AGC stage, the gain of the output signal in accordance with the G_{N} value to obtain a gain-controlled output signal.

38. The method of claim 37 wherein said automatic gain controlling step further includes:
setting the previous variance σ_{N-1} to the calculated variance σ_{N}; and
repeating said generating step, said accumulating step, said first repeating step, said calculating step, said reversing step, said adding step, and said controlling step.

39. In a system for performing wireless ranging measurements, a method of automatic gain control (AGC) of an output signal generated from a wireless input signal, the output signal having an associated gain, said system including at least one wireless device having at least one processor and an AGC stage for controlling the gain of the output signal in accordance with a gain control (G_{N}) value, said at least one processor including a buffer, the G_{N} value having an associated incremental (ΔG) value, the ΔG value having an associated sign, said method comprising the steps of:
in a generating step, generating, from the output signal, at least one quadrature-phase (Q) signal, the Q signal having an associated magnitude (|Q|) value;
in an accumulating step, accumulating the |Q| value of the Q signal in said buffer;
in a first repeating step, repeating said generating step and said accumulating step until a specified number of |Q| values are accumulated in said buffer;
in a calculating step, in the event said specified number of |Q| values of the Q signal are accumulated in said buffer, calculating a variance (σ_{N}) of the |Q| values accumulated in said buffer;
in a reversing step, in the event the calculated variance σ_{N} is greater than a previous variance (σ_{N-1}), reversing the sign of the ΔG value;
in an adding step, adding the ΔG value to a previous gain control (G_{N-1}) value to obtain the G_{N} value; and
in a controlling step, controlling, by said AGC stage, the gain of the output signal in accordance with the G_{N} value to obtain a gain-controlled output signal.

40. The method of claim 39 further including:
setting the previous variance σ_{N-1} to the calculated variance σ_{N}; and
repeating said generating step, said accumulating step, said first repeating step, said calculating step, said reversing step, said adding step, and said controlling step.
